(19) United States
(12) Patent Application Publication
(10) Pub. No.: US 2021/0120806 A1
(43) Pub. Date: Apr. 29, 2021

(54) Chemical Dispersant With Animal-Deterrent Visual Effects

(71) Applicant: Bird-B-Gone, Inc., Irvine, CA (US)

(72) Inventor: Bruce Donoho, Laguna Beach, CA (US)

(21) Appl. No.: 16/661,873

(22) Filed: Oct. 23, 2019

(51) Int. Cl. A01M 29/12; A01M 29/08

(52) U.S. Cl. CPC A01M 29/12; A01M 29/08

(57) ABSTRACT

A deterrent device for birds or other animals from target location uses a combination of light reflectors and an odor that acts as a deterrent against birds. A collection of the light reflectors can be disposed in gel having an odor-releasing composition. The gel can be disposed in a dish or an adhesive tape which should be positioned in close proximity to the location where birds or other animals should be deterred.

### FIELD OF THE INVENTION

The field of the invention is animal deterrent devices.

### BACKGROUND THE INVENTION

The following description includes information that may be useful in understanding the present invention. It is not an admission that any of the information provided herein is prior art or relevant to the presently claimed invention, or that any publication specifically or implicitly referenced is prior art.

There are numerous products on the market for deterring birds and other animals. Such products include mechanical deterrents such as spikes, and electrical deterrents such as shock strips. Those product are only useful, however, upon contact and potentially at very close distance. An alternative is to deter birds and other animals using light, which operates at a greater distance.

CN 106998674A teaches repelling birds from field crops using small particles that absorb ultraviolet (UV) light. Birds can sense the location of field crops by the presence of UV light reflected from the crops. When such particles are disposed on field, the reduction in reflected UV light is thought to deter birds from landing on the crops.

CN 106998674A and all other publications discussed herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Light (visible) reflecting flakes have also been used to deter birds. An example is depicted in the Japanese product depicted at https://store.shopping.yahoo.co.jp/ssnet/fukui-4935682006193.html# (see FIG. 1). One problem is that birds tend to become tolerant to the flickering light reflections, and eventually leads the birds to ignore the product altogether.

A different product shown in https://www.amazon.com/Bird-Barrier-Multi-Sensory-Repellent-Alternative/dp/B01MQSRJQ6 and FIG. 2, seeks to deter birds by releasing a deterrent odor. However, the product of FIG. 2 is not particularly reflective in visible, UV, or any other wavelengths, and therefore still only has a single mode of deterrence.

What hasn't been appreciated in the prior art is that to effectively deter birds and other animals, even after the odor is no longer being dispensed in a significant amount, one needs to use a device that causes the target animals to associate the deterrent odor with a distinguishing light pattern. In that manner the device would continue to operate even after the odor is greatly diminished, or is downwind of the animal.

### SUMMARY OF THE INVENTION

The inventive subject matter provides apparatus and methods for deterring birds or other from a target location, using a combination of a deterrent odor and a distinguishing light pattern.

The current inventor contemplates that a collection of reflective flakes would be especially advantageous in producing a distinguishing light pattern. One rationale is that the reflections of such flakes are not static, but would instead tend to flicker as a bird or other animal moves in relation to the flakes. And it is especially contemplated that such reflections would be advantageous in the UV range, which birds and some other animals can see.

As used herein, the term “flake” means a small, flat, thin piece of material, having a length to thickness aspect ratio of at least 5. For example, the length and the thickness of contemplated flakes could be 5 mm by 1 mm, respectively, or 2 mm by 0.2 mm, respectively.

In preferred embodiments, at least some of the light reflectors in a collection of flakes reflect at least 60% of ambient UV light between 300 nm and 400 nm, inclusive, and/or at least 60% of ambient visible light between 400 nm and 750 nm, inclusive, based upon an area under the curve (AUC) measurement.

To achieve such reflectivity, it is contemplated that at least some of the light reflectors could be made entirely of Mylar™ or other shiny plastic, metallic aluminum, or a dielectric mirror substance. In other contemplated embodiments, light reflectors could be at least partially coated by a reflective substance.

The light reflectors can be advantageously contained in a dish. In some embodiments, light reflectors can be disposed in a gel, liquid, or solid, which can itself be contained in a dish. Gels are preferred because they tend to be sticky, which can add yet a third mode of deterrence.

Odors used in conjunction with flakes or other light reflectors are preferably chosen from one or more of peppermint oil, citronella, grape (methyl anthranilate), and lemon, each of which is thought to act as a deterrent to birds. When birds sense these smells, they tend to avoid whatever area has a higher concentration of the smell.

Odors can be configured to emanate from An odor-releasing composition which is disposed in the dish, the gel or other material that includes the light reflectors, or odors from the light reflectors themselves. An odor-releasing composition can be present in liquid, solid, powder, or any other form.

The deterrent odor can emanate from any suitable liquid, solid, or powder form of an odor-releasing composition that can be disposed in the flake retaining material

In some embodiments, the gel having flakes and the odor-releasing composition can be disposed on an adhesive tape, in a manner similar to flypaper.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a perspective view of a prior art bird deterrent in which shiny flakes are contained in mostly transparent container.

FIG. 2 is a perspective view of another prior art bird deterrent that having an opaque material that emits a bird deterrent odor, but that is neither shiny nor flickering.

FIG. 3 is a perspective view of an embodiment of a shiny, flake type of light reflector.

FIG. 4 is a perspective view of an embodiment in which a gel (or other flake retaining material), and multiple shiny, flake type of light reflectors, are disposed in a cavity of a dish.

FIG. 5A is a perspective view of an embodiment in which an adhesive gel, and multiple shiny, flake type of light reflectors, are disposed on a surface of a tape, and the tape is adhered to a surface.

FIG. 5B is a perspective view of an embodiment in which an adhesive gel, and multiple shiny, flake type of light reflectors, are disposed on a surface of a hanging tape.

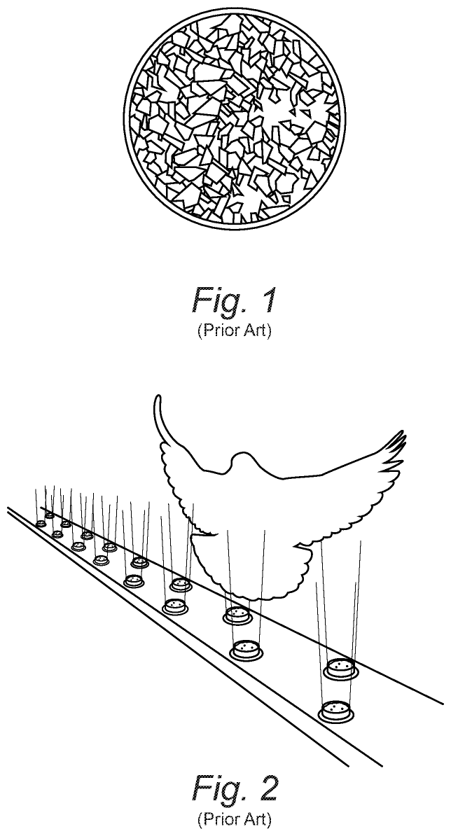

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

The recitation of ranges of values herein is merely intended to serve as a shorthand method of referring individually to each separate value falling within the range. Unless otherwise indicated herein, each individual value is incorporated into the specification as if it were individually recited herein.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The basic inventive concept is to deter birds and potentially other animals from target building, furniture or other objects or region, using a deterrent odor in combination with light reflectors that provide one or more distinguishing light patterns. Especially preferred embodiments use flakes to produce light patterns that are dynamic by virtue of appearing to flicker when a viewer moves relative to the flakes.

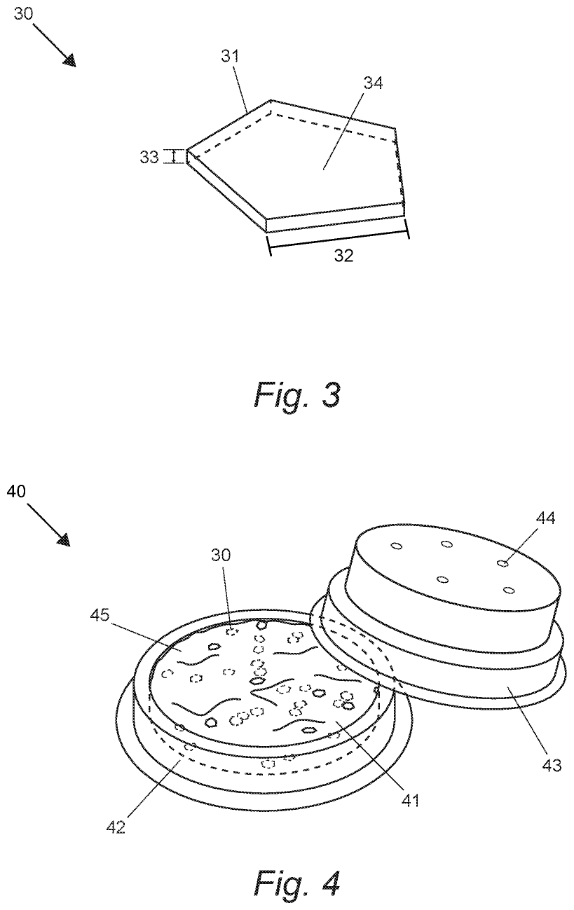

FIG. 3 shows one embodiment of a light reflector (30) that is a flake (31), having a longest linear sides (32) and a greatest thickness (33). In preferred embodiments the longest linear sides is less than 2 cm, more preferably less than 1 cm, and still more preferably less than 3 mm. Also in preferred embodiments the greatest thickness is less than 2 mm, more preferably less than 1 mm, and still more preferably less than 0.2 mm. The length to thickness aspect ratio is preferably greater than 5, more preferably greater than 10, and still more preferably greater than 20. In some instances, flake can be manufactured by being broken away, cut, or peeled off from a larger piece.

It is highly advantageous for light reflectors to have at least one substantially flat plane (34) because it enhances the intensity of reflected light, and tends to be viewed as flickering.

In preferred embodiments, at least some of the light reflectors in a collection of flakes reflect at least 60% of ambient UV light between 300 nm and 400 nm, inclusive, and/or at least 60% of ambient visible light between 400 nm and 750 nm, inclusive, based upon an area under the curve (AUC) measurement. A more preferred embodiment includes some light reflectors reflecting at least 70% of ambient UV and/or 70% of ambient visible light. A still more preferred embodiment includes some light reflectors reflecting at least 80% of ambient UV and/or 80% of ambient visible light.

Light reflectors (30) can advantageously be entirely or partially made of a reflective substance that includes of Mylar™ or other shiny plastic, metallic aluminum, or a dielectric mirror substance. Some or all of individual light reflectors can additionally or alternatively be coated with a reflective substance.

FIG. 4 is a perspective view of an embodiment in which a gel (41), or other flake retaining material), and multiple shiny, flake type of light reflectors (30), are disposed in a cavity of a dish (42). In this particular embodiment, there are numerous flakes are randomly disposed within the flake retaining material, such that reflections from the flakes will be present when viewed from many different angles.

The flake retaining material is preferably substantially transparent, to maximize apparent reflectivity from the flakes to a bird or other animal.

The deterrent odor can emanate from any suitable liquid, solid, or powder form of an odor-releasing composition (45) that can be disposed in the gel (41). The odor is preferably chosen from one or more of peppermint oil, citronella, grape (methyl anthranilate), and lemon, each of which is thought to act as a bird deterrent. One expected benefit from the claimed combination of deterrent odor(s) and distinguishing light pattern is that birds can be deterred from relatively far distances compared, for example, with the use of spikes or shock tracks where birds are detected by the device only at close proximity.

In the embodiment of FIG. 4, the dish (42) has a lid (43) with at least one optional hole (44) to release odor to ambient air. The lid can thus protect any enclosed gel or other material from rain and other materials that might wash away or otherwise impede the apparent reflectivity of the flakes, while still allowing the repellent odor to escape into the atmosphere. In a preferred embodiment, the total area for the holes (44) is at least 10% of the entire surface area of the light reflector. In a more preferred embodiment, the total area for the holes is at least 15% of the entire surface area on the light reflector.

Where a cover (43) with holes (44) is utilized, the cover (43) should be substantially transparent to both visible and UV light, thereby maximizing apparent reflectivity of the light reflectors (30) to a bird or other animal. In a preferred embodiment, the material of the cover transmits at least 70% of the reflected light. In a more preferred embodiment, the material of the cover transmits at least 80% of the reflected light. In a most preferred embodiment, the material of the cover transmits at least 85% of the reflected light. Suitable materials for the cover include transparent plastics, for examples, PET, polystyrene, polypropylene, polyethylene, PMMA, and polycarbonate.

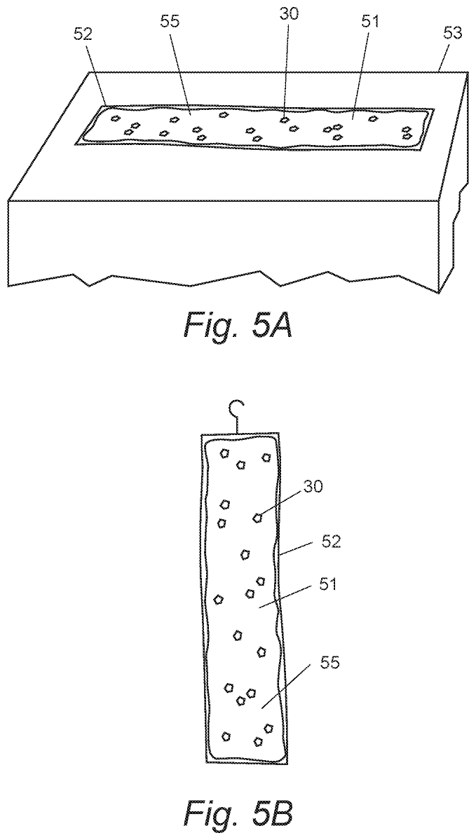

As shown in FIG. 5A an adhesive gel (51), and multiple shiny, flake type of light reflectors (30), and odor-releasing composition (55), are disposed on an adhesive surface of a tape (52), which is adhered to a surface of a building (53).

As shown in FIG. 5B an adhesive gel (51), and multiple shiny, flake type of light reflectors (30), and odor-releasing composition (55), are disposed on an adhesive surface of a hanging tape (52).

It is also contemplated that flake type of light reflectors discussed herein could be disposed in an adhesive gel or other deterrent odor-emitting material, and spread onto a surface of a building, onto furniture, or other surface from which birds or other animals are to be deterred. The material could eventually wash away, either by environmental factors or intentionally using a solvent, and could then be reapplied as desired. In this manner a ledge or other relatively large surface could be conveniently coated with the light reflecting and odor-emitting material, rather than using numerous discrete containers.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A device for deterring birds, the device comprising a container having an openable lid, the container configured to (a) retain a collection of discrete iridescent flakes reflective in at least a UV range perceptible to birds, and an odor-releasing composition, and (b) evaporate a bird-deterring odor from the odor-releasing composition in an amount sufficient to repel ambient birds, while the iridescent flakes and the odor-releasing composition remain within the container.

2. The device of claim 1, wherein at least some of the iridescent flakes have a length to thickness aspect ratio of at least 5.

3. The device of claim 1, wherein at least some of the iridescent flakes have at least one substantially flat plane.

4. The device of claim 1, wherein at least some of the iridescent flakes reflect at least 60% of ambient ultraviolet light (300-400 nm) and at least 60% of ambient visible light (400-750 nm) based upon an area under the curve measurement.

5. The device of claim 1, wherein at least some of the iridescent flakes have a reflective substance.

6. The device of claim 5, wherein the reflective substance is selected from the group consisting of Mylar™ or other shiny plastic, metallic aluminum, or a dielectric mirror substance.

7. The device of claim 1, wherein the odor is selected from at least one of the group consisting of peppermint and citronella, grape, and lemon.

8. The device of claim 1, wherein the collection of the iridescent flakes is housed within a dish.

9. The device of claim 8, further comprising a gel inside of the dish, wherein each of the odor-releasing composition and the collection of the iridescent flakes is disposed within the gel.

10. The device of claim 9, wherein the dish has a cover that transmits (a) at least 60% of ambient ultraviolet (300-400 nm) and at least 60% of ambient visible light (400-750 nm), and (b) is permeable to the odor.

11. The device of claim 10, wherein the cover has at least one hole configured to release the odor.

12. The device of claim 1, wherein at least some of the iridescent flakes are disposed onto a tape.

13. A method for deterring birds, comprising:
obtaining iridescent light reflectors configured to (a) reflect at least 60% of ambient ultraviolet light (300-400 nm) and (b) have a length to thickness aspect ratio of at least 5;
disposing the light reflectors in a retaining device having an openable lid, in combination with an odor-releasing composition selected to release an odor that is deterrent to the animal; and
wherein the container and the openable lid are configured to allow evaporation of the deterrent odor in an amount sufficient to repel ambient birds, while the iridescent light reflectors and the odor-releasing composition remain within the container.

14. The method of claim 13, wherein at least some of the iridescent light reflectors are flakes.

15. The method of claim 13, wherein the retaining device comprises a gel.

16. The method of claim 13, wherein the retaining device comprises a dish having a cover.

17. The method of claim 13, wherein at least some of the iridescent light reflectors have a reflective substance.

18. The device of claim 17, wherein the reflective substance is selected from the group consisting of Mylar™ or other shiny plastic, metallic aluminum, or a dielectric mirror substance.

19. The method of claim 13, wherein the odor is selected from at least one of the group consisting of peppermint, citronella, grape, and lemon.

20. The method of claim 13, further comprising coupling an adhesive to an underside of the retaining device.
